(19) United States
(12) Patent Application Publication
(10) Pub. No.: US 2007/0117008 A1
(43) Pub. Date: May 24, 2007

(54) STACK-TYPE LITHIUM-ION POLYMER BATTERY

(76) Inventors: Shinako KANEKO, Sendai-shi, Miyagi (JP); Ryuichi KASAHARA, Sendai-shi, Miyagi (JP); Hiroshi KOBAYASHI, Sendai-shi, Miyagi (JP); Yasutaka KONO, Sendai-shi, Miyagi (JP); Toshihiko NISHIYAMA, Sendai-shi, Miyagi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/561,754

(22) Filed: Nov. 20, 2006

(30) Foreign Application Priority Data
Nov. 21, 2005 (JP) 2005-335717

(51) Int. Cl. H01M 2/02; H01M 2/08

(52) U.S. Cl. 429/152; 429/176; 429/185

(57) ABSTRACT

The present invention provides a stack-type lithium-ion polymer battery wherein: the battery capacity is not being degraded; the generation of the wrinkles and fracture of the separator is being suppressed; the battery has gas releasing paths; the displacement of an electrode stack hardly occurs; and the workability at the time of placing the electrode stack in a package body is improved by fixing the electrode stack. A stack-type lithium-ion polymer battery of the present invention comprises: a cathode 13; an anode 14; a separator 15; and a gel electrolyte; wherein an electrode stack 23 in which the cathode 13 and the anode 14 are stacked through the separator 15 is enclosed and fixed by insulating porous sheets 21 and 24, and is packaged with a laminate material.

### BACKGROUND OF THE INVENTION

1. Field of the Invention

The present invention relates to a stack-type lithium-ion polymer battery and, more particularly, to a stack-type lithium-ion polymer battery packaged with a laminate material.

2. Description of the Related Art

Because a lithium-ion polymer battery has an improved resistance to liquid leakage owing to nonuse of any electrolyte, a laminate package body which affords satisfactory productivity can be used and the battery packaged with a laminate material is characterized by having a high degree of freedom in selecting the shape thereof.

At present, prismatic lithium-ion polymer batteries, packaged with a laminate material, include a wound-type battery in which wound electrodes are formed into a flat shape and a stack-type battery in which flat plate electrodes are stacked.

In the stack-type battery, a cathode, a separator and an anode are sequentially stacked in this order to fabricate an electrode stack. When a gel electrolyte is used, the separator is required to be made thinner because the gel electrolyte has a lower ion conductivity and a larger resistance than that of an electrolyte. When the separator is made thinner, a micro short-circuit may be formed due to contaminants or the like, but the gel electrolyte formed in the interfaces between the electrodes and the separator alleviates these phenomena, and hence the separator can be made thinner. However, such a thin separator is difficult in handling, tends to undergo the displacement thereof when stacked, which may cause the formation of an internal short-circuit and the increase of the resistance due to the generation of wrinkles. In some cases, there is adopted a structure in which a self-supported gel electrolyte sheet is used instead of using the separator; however, a short-circuit may be formed due to the decrease of the strength of the gel electrolyte when the temperature is raised, and hence the safety thereof has not been sufficient.

For the purpose of solving this problem, there has been proposed a battery in which either one of a cathode and an anode is placed in a support body formed in a bag-like shape which consists of a porous sheet so as to be integrated with the electrode (for example, Japanese Patent Application Laid-Open No. 2000-188130). However, when a gel electrolyte is used, the speed of a pre-gel solution, which is prepared by adding a gelation component to an electrolytic solution, for passage through the porous sheet is decreased because the pre-gel solution has a higher viscosity than that of only a electrolytic solution, and the porosity of a porous sheet, which is made thinner, is decreased in order to maintain the strength thereof. Herewith, when an electrode is enclosed in the bag-like porous sheet, the impregnation of the pre-gel solution into the electrode is degraded. Also when the pre-gel solution is impregnated under a reduced pressure, the gas layer which is present in the space between the active materials is needed to be released to the outside; however, the path for releasing the gas is also limited because the support body is formed in the bag-like shape; and thus, the gas may remains. Also when the electrode units enclosed by the porous sheet are stacked and placed in a package body, the electrodes each are independently stacked, and hence there has been a problem of poor workability.

Additionally, there has been proposed a battery in which peripheries of two or more bag-like separators of a prismatic battery are, partially or wholly, mutually fixed by fusion bonding to each other, to fix a group of electrodes (for example, Japanese Patent Application Laid-Open No. 10-64506). According to the document, the group of the electrodes fixed is placed as the electrode stack longitudinally in a package can case. Although the releasing paths of the gas generated when the electrolyte is impregnated under a reduced pressure can be ensured, wrinkles on the separators may be generated by the friction due to the contact between the package case and the separators on an outermost layer of the group of the electrodes at the time of placing when the outermost layer of the group of the electrodes is enclosed by the separators. Additionally, the separators interposed between the stacked electrodes undergo the generation of fracture due to the wrinkles or the tensile caused by the tension by the wrinkles of the outermost layer of the group of the electrodes, possibly to generate a short-circuit fault. Also when the outermost layer of the group of the electrodes is a cathode or an anode, it is necessary to form a certain gap between the separator portion fixed by fusion bonding and the package body. Thus, there has been a drawback that the volume efficiency is thereby degraded. Additionally, when the gap is small, the fracture due to the wrinkles or the tensile caused by the contact with the package can may be generated. Further, there have been drawbacks including poor workability by the fact that a displacement tends to occur when an electrode is disposed on the outermost layer of the group of the electrodes at the time of placing in the package body.

Further, as a method for fixing a group of electrodes, there has been known a method in which the peripheries of the group of stacked electrodes is fixed with an adhesive tape or the like; however, there has been a problem that the volume efficiency is degraded and the impregnation of the electrolyte or the pre-gel solution is inhibited due to the absence of pores in the adhesive tape or the like, and hence the capacity is degraded.

To a stack-type lithium-ion polymer battery, a thin separator can be applied for the purpose of reducing the resistance of the gel electrolyte layer and improving the volume efficiency thereof. However, the application of such a thin separator may cause the formation of an internal short-circuit due to the electrode displacement when stacked and the increase of resistance due to the generation of wrinkles. When a cathode or an anode is placed in a bag-like separator to be stacked, an internal short-circuit due to the electrode displacement can be suppressed. However, the workability is poor because the electrodes each are independently stacked when the electrode units enclosed by the porous sheet are stacked and placed in a package body. Further, the releasing paths of the gas generated when a pre-gel solution is impregnated under vacuum become fewer to increase the residual gas.

### SUMMARY OF THE INVENTION

The present invention provides a stack-type lithium-ion polymer battery wherein: the battery capacity is not being degraded; the generation of the wrinkles and fracture of the separator is being suppressed; the battery has gas releasing paths; the displacement of an electrode stack does not occur; and the workability at the time of placing the electrode stack in a package body is improved.

For the purpose of solving the above-mentioned problems, a stack-type lithium-ion polymer battery of the present invention comprises: a cathode; an anode; a separator; and a gel electrolyte; wherein an electrode stack in which the cathode and the anode are stacked through the separator is enclosed and fixed by an insulating porous sheet, and is packaged with a laminate material.

Additionally, in the stack-type lithium-ion polymer battery of the present invention, the separator and the insulating porous sheet enclosing the electrode stack may be fusion-bonded and fixed at least at one position in the peripheral portion of the side of the electrode stack, not in contact with the cathode and the anode.

Additionally, in the stack-type lithium-ion polymer battery of the present invention, the separator and the insulating porous sheet enclosing the electrode stack may be fusion-bonded and fixed discontinuously at least at two positions in the peripheral portion of the side of the electrode stack, not in contact with the cathode and the anode.

Additionally, in the stack-type lithium-ion polymer battery of the present invention, the separator and the insulating porous sheet enclosing the electrode stack may be integrated on the lower end surface or the upper end surface of the side of the electrode stack, and may be fusion-bonded and fixed discontinuously at least at two positions in the peripheral portion of the side of the electrode stack, not in contact with the cathode and the anode.

Additionally, in the stack-type lithium-ion polymer battery of the present invention, the fusion-bonded portions of the separator and the insulating porous sheet may be bent so as to be parallel to the side of the electrode stack.

According to the present invention, there can be provided a stack-type lithium-ion polymer battery wherein: the two or more separators and the insulating porous sheet enclosing the electrode stack are fusion-bonded and fixed to each other, so that the displacement of the electrodes can be prevented, the formation of the internal short-circuit can be prevented, the production yield can be improved, the generation of wrinkles, at the time of impregnation of the pre-gel solution or the like, during or after stacking, can be suppressed, and the formation of the internal short-circuit and the capacity degradation can be prevented; the separators and the insulating porous sheet are fusion-bonded and fixed in the peripheral portion thereof, not in contact with the electrodes, so that the gas releasing paths at the time of the impregnation of the pre-gel solution can be ensured and the capacity degradation can be prevented; the separators and the insulating porous sheet are fusion-bonded and fixed to each other in a lumped manner when the electrodes are stacked, so that the time for fabricating the electrode stack can be shortened; the two or more electrodes are all fixed by the separators and the insulating porous sheet, so that the workability at the time of placing the electrode stack into a package body can be drastically improved; the insulating porous sheet is disposed on the outermost surface of the group of the electrodes, so that the liquid retention property inside the battery can be enhanced and accordingly the deficiency of the gel electrolyte can be prevented to favorably affect the cycle property; the embossed laminate package body is used, so that the tensile due to the friction between the package body and the insulating porous sheet is reduced at the time of placing the electrode stack into the package body and accordingly the internal short-circuit due to wrinkles and fracture is prevented; and the battery has an excellent volume efficiency.

### BRIEF DESCRIPTION OF THE DRAWINGS

FIG. 1 is a sectional view illustrating the state when insulating porous sheets enclosing the electrode stack are being fusion-bonded and fixed in Example 1 of the stack-type lithium-ion polymer battery of the present invention;

FIG. 2 is an oblique perspective view illustrating the state after fusion-bonding and fixing the insulating porous sheets illustrated in FIG. 1;

FIG. 3 is an oblique perspective view illustrating the state after bending the fusion-bonded portions of the insulating porous sheets illustrated in FIG. 2 and attaching tabs therein;

FIG. 4 is an oblique perspective view illustrating the state when the electrode stack illustrated in FIG. 3 is being placed into the laminate package body;

FIG. 5 is a sectional view illustrating the state after packaged with the laminate material in Example 1 of the stack-type lithium-ion polymer battery of the present invention;

FIG. 6 is a sectional view illustrating the state when insulating porous sheets enclosing the electrode stack are being fusion-bonded and fixed in Example 2 of the stack-type lithium-ion polymer battery of the present invention;

FIG. 7 is an oblique perspective view illustrating the state after fusion-bonding, fixing and bending the insulating porous sheets illustrated in FIG. 6;

FIG. 8 is an oblique perspective view illustrating the state when the electrode stack is being placed into the laminate package body in Example 3 of the stack-type lithium-ion polymer battery of the present invention;

FIG. 9 is a sectional view illustrating the state after placing the electrode stack illustrated in FIG. 8 into the laminate package body;

FIG. 10 is a sectional view illustrating the state after the fusion-bonding, fixing and bending the insulating porous sheets enclosing the electrode stack in Example 4 of the stack-type lithium-ion polymer battery of the present invention;

FIG. 11 is a perspective view illustrating the electrode stack in Comparative Example 1;

FIG. 12 is a perspective view illustrating the electrode stack in Comparative Example 2; and

FIG. 13 is a sectional view illustrating the electrode stack after fusion-bonded and fixed in Comparative Example 3.

### DETAILED DESCRIPTION OF THE PREFERRED EMBODIMENTS

Next, the embodiments of the present invention will be described, but the present invention is not limited to these embodiments.

First, materials will be described.

Examples of a cathode active material may include metal oxide cathode materials such as LiCoO₂, LiNi₁₋ₓCoₓO₂, LiMn₂O₄ and LiNiₓMn₂₋ₓO₄. Examples of an anode active material may include graphite and lithium metal but are not limited to them. The former is preferable in consideration of the safety for the purpose of packaging with a laminate material.

A separator is not particularly limited, but may be any of those commonly used in lithium polymer batteries such as those made of a nonwoven fabric and a polyolefin microporous membrane. The separator may be a porous material and the materials for the separator may be polyethylene, polypropylene, polystyrene or polytetrafluoroethylene. The separator is preferably a polyethylene microporous membrane with a membrane thickness of 5 to 25 μm, and more preferably 7 to 16 μm. The insulating porous sheets to be disposed on the upper end surface and the lower end surface of the electrode stack are not necessarily required to be the same in material and membrane thickness as the separator disposed between the electrodes, and the material and the membrane thickness thereof can be selected according to need.

Examples of a gelation component to be contained in a gel electrolyte may include a monomer and an oligomer, having two or more thermally polymerizable groups per one molecule, and a copolymerizable oligomer. Examples of the gelation component may include: bifunctional acrylates such as ethylene glycol diacrylate, diethylene glycol diacrylate, triethylene glycol diacrylate, tetraethylene glycol diacrylate, propylene diacrylate, dipropylene diacrylate, tripropylene diacrylate, 1,3-butanediol diacrylate, 1,4-butanediol diacrylate and 1,6-hexanediol diacrylate; trifunctional acrylates such as trimethylolpropane triacrylate and pentaerythritol triacrylate; tetrafunctional acrylates such as ditrimethylolpropane tetraacrylate and pentaerythritol tetraacrylate; and the methacrylate monomers corresponding to the above-mentioned acrylate monomers.

In addition to the above-mentioned gelation components, examples of the gelation component may include: monomers such as urethane acrylate and urethane methacrylate; copolymerized oligomers of these monomers; and copolymerized oligomers of these monomers with acrylonitrile.

Additionally, examples of the gelation component may also include polymers, capable of dissolving in a plasticizer and being gelatinized, such as polyvinylidene fluoride, polyethylene oxide and polyacrylonitrile.

The gelation component is not limited to the above described monomers, oligomers and polymers, but any material capable of being gelatinized can also be used. Additionally, the gelation component is not limited to one monomer, one oligomer or one polymer, but the mixture of two or more gelation components can be used according to need.

As the plasticizer to be contained in the gel electrolyte, any of organic solvents commonly used for lithium ion batteries can be used, such as ethylene carbonate, propylene carbonate, dimethyl carbonate, diethyl carbonate, methyl ethyl carbonate, methyl propionate, γ-butylolactone and 1,2-dimethoxyethane.

As a electrolyte to be contained in the gel electrolyte, any of electrolytes commonly used for lithium ion batteries can be used, such as LiPF₆, LiBF₄, LiAsPF₆, LiCF₃SO₃ and LiN(CF₃SO₂)₂.

According to need, benzoins, peroxides and the like can be used as a thermal polymerization initiator.

Next, the configuration will be described.

A stack-type lithium-ion polymer battery of the present invention has a configuration in which an electrode stack, fabricated by sequentially stacking a cathode in which a cathode active material is formed on a cathode current collector and an anode in which an anode active material is formed on an anode current collector through a separator which is larger in area than the anode, is enclosed and fixed by an insulating porous sheet.

Specifically, the stack-type lithium-ion polymer battery packaged with a laminate material is obtained as follows: the electrode stack, in which the separators which are bent along the side of the electrode stack and the insulating porous sheets enclosing the stack are integrated on the lower end surface of the electrode stack, and which have a portion fusion-bonded and fixed to each other discontinuously at least at one position in the peripheral portion, not in contact with the electrodes, is placed in a laminate package body; a pre-gel solution is injected from an edge having a portion in which the insulating porous sheets are not fusion-bonded and fixed and is impregnated under vacuum; thereafter, the pre-gel solution injection portion is fusion-bonded under a reduced pressure; and the pre-gel solution is gelatinized by heating.

Additionally, the stack-type lithium-ion polymer battery can also be obtained as follows: the electrodes or the separators are beforehand coated with the gelation component; the electrode stack, in which the separators and the insulating porous sheets enclosing the stack are integrated on the lower end surface of the electrode stack, and which have a portion fusion-bonded and fixed to each other discontinuously at least at one position in the peripheral portion, not in contact with the electrodes, is placed in a laminate package body; a plasticizer and an initiator component necessary for polymerization according to needed are injected and are impregnated under vacuum; thereafter, the injection portion is fusion-bonded under a reduced pressure; and the gelation is carried out according to need.

The present invention includes a case where the separators and the electrodes are stacked and thereafter the separators and the insulating porous sheets are integrated on the lower end surface or the upper end surface of the electrode stack to be fusion-bonded and fixed to each other, and a case where a predetermined number of separators and insulating porous sheets are stacked to be fusion-bonded and fixed and thereafter the electrodes are interposed therebetween. There is also included a case where after the separator and the insulating porous sheet are fusion-bonded and fixed at least at one or more positions, the electrodes are interposed in such a way that the fusion-bonded portions are located on the lower end surface or the upper end surface of the stack, and subsequently the non-fusion-bonded portions are fusion-bonded.

Additionally, examples of means for fixing the insulating porous sheets to each other include thermal fusion-bonding, pressure bonding, and ultrasonic fusion-bonding.

### EXAMPLE 1

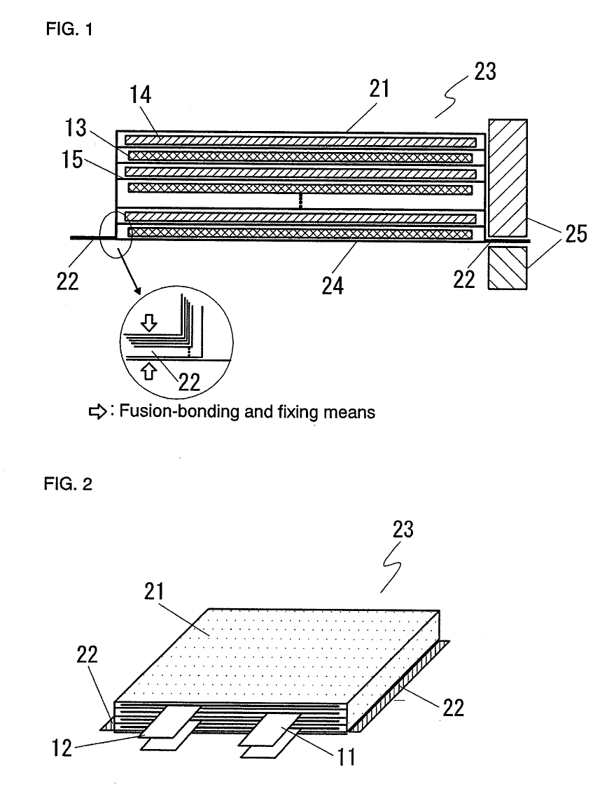

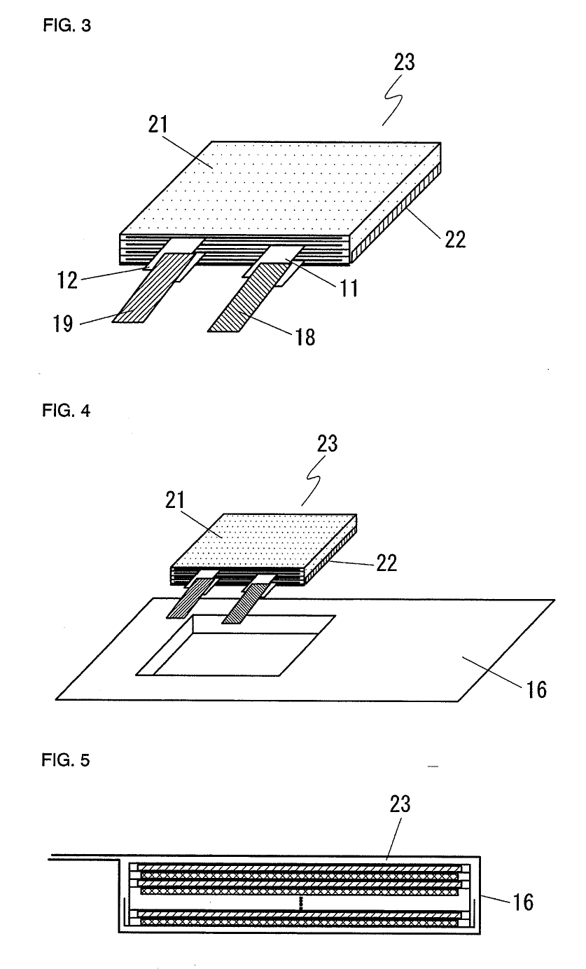

Example 1 will be described with reference to FIGS. 1 to 5. FIG. 1 is a sectional view illustrating the state when insulating porous sheets enclosing the electrode stack are being fusion-bonded and fixed in Example 1 of the stack-type lithium-ion polymer battery of the present invention; FIG. 2 is an oblique perspective view illustrating the state after fusion-bonding and fixing the insulating porous sheets illustrated in FIG. 1; FIG. 3 is an oblique perspective view illustrating the state after bending the fusion-bonded portions of the insulating porous sheets illustrated in FIG. 2; FIG. 4 is an oblique perspective view illustrating the state when the electrode stack illustrated in FIG. 3 is being placed into the laminate package body; and FIG. 5 is a sectional view illustrating the state after packaged with the laminate material in Example 1 of the stack-type lithium-ion polymer battery of the present invention.

A cathode 13 was fabricated as follows. First, a mixture was prepared by mixing 85% by weight (hereinafter represented by wt %) of LiMn₂O₄, 7 wt % of acetylene black as a conductive additive and 8 wt % of polyvinylidene fluoride as a binder. To this mixture, N-methylpyrrolidone was added, and the mixture thus obtained was further mixed to prepare a cathode slurry. The slurry was coated on the both surfaces of Al foil with a thickness of 20 μm to be a current collector in such a way that the thickness after roll pressing was 160 μm. Further, an uncoated portion connected to the coated portion was formed on the foil to be used for a current collecting terminal, and the foil was cut to form a 70 mm×150 mm electrode portion with the uncoated portion left to be a current collecting terminal to fabricate the cathode 13.

An anode 14 was fabricated as follows. A mixture was prepared by mixing 90 wt % of graphite and 10 wt % of polyvinylidene fluoride as a binder. To this mixture, N-methylpyrrolidone was added, and the mixture thus obtained was further mixed to prepare an anode slurry. The slurry was coated on the both surfaces of Cu foil with a thickness of 10 μm to be a current collector in such a way that the thickness after roll pressing was 120 μm. Further, an uncoated portion connected to the coated portion was form on the foil to be used for a current collecting terminal, and the foil was cut to form a 73 mm×160 mm electrode portion with the uncoated portion left to be a current collecting terminal to fabricate the anode 14.

As a separator 15 and insulating porous sheets 21 and 24, microporous membranes made of polyethylene with a membrane thickness of 12 μm and a porosity of 35% were used.

A pre-gel solution was prepared as follows. An electrolyte was prepared so as to contain 30 wt % of ethylene carbonate (EC), 58 wt % of diethyl carbonate (DEC) and 12 wt % of LiPF₆ as a lithium salt. To this electrolyte, 3.8 wt % of triethylene glycol diacrylate and 1 wt % of trimethylolpropane triacrylate were added, and the mixture thus obtained was fully mixed. Thereafter, to the mixture thus obtained, 0.5 wt % of t-butyl peroxypivalate was added as a polymerization initiator to prepare the pre-gel solution.

Next, the fabrication of an electrode stack 23 will be described.

The insulating porous sheet 24, which had been cut to 100 mm×170 mm so as to be larger than the coated area of the anode, was placed at a predetermined position; and the cathode 13, the separator 15, the anode 14 and additionally the separator 15 were sequentially stacked in this order so as to form 10 pairs of the cathodes and the anodes. In this case, the insulating porous sheet located on the uppermost surface corresponds to the insulating porous sheet 21 on the upper end surface of the electrode stack 23. Then, a portion, which was not in contact with the electrodes and was one of the edges corresponding to the sides in relation to the edges of a cathode terminal 11 and an anode terminal 12 to serve as current collectors, was fusion-bonded and fixed by applying a fusion-bonding jig 25 from the above, to form a fusion-bonded portion 22 with a fusion-bonding width of 2 mm in such a way that the fusion-bonded portion was located on the lower end surface of the electrode stack 23, as shown in FIG. 1. The other side was also fusion-bonded and fixed in the same manner and was cut in such a way that the fusion-bonded portion had a width of 2 mm, to fabricate the electrode stack 23 enclosed by the insulating porous sheets, as shown in FIG. 2.

Next, as shown in FIG. 3, the fusion-bonded portions 22 were bent by 90° so as to be parallel to the side of the electrode stack toward the upper end surface of the electrode stack. The electrode stack 23 had a thickness of 3.15 mm, and hence when the fusion-bonded portions 22 with a width of 2 mm were bent, the bent portions were within the thickness of the electrode stack 23.

Next, tabs for access to outside were attached to the electrode current collecting portions. An aluminum tab 18 was used for the cathode terminal 11 and a nickel tab 19 was used for the anode terminal 12.

Successively, as shown in FIG. 4, the electrode stack 23 was placed into an embossed laminate package body 16. In this case, the laminate package body 16 and the electrode stack 23 were contacted to each other only at the bent fusion-bonded portions 22, and the bent fusion-bonded portion 22 had an increased strength as compared to the insulating porous sheets themselves. Consequently, the electrode stack could be placed without the generation of wrinkles or fracture due to friction and also without occurring the displacement of the electrodes.

Next, as shown in FIG. 5, one edge of the embossed laminate package body placing the electrode stack 23 was bent, and thermal fusion-bonding was carried out except for the portion to use in injection of the pre-gel solution.

Next, the pre-gel solution was injected from the injection portion and was impregnated under vacuum. Thereafter, the rest portion was fusion-bonded by heating under reduced pressure. In this case, the injection was carried out from the portion of the insulating porous sheets which was not fusion-bonded and fixed, in consideration of the impregnatability and the gas release.

The battery sealed with a laminate material was treated at 80° C. for 2 hours to carry out the gelation, and thus the stack-type lithium-ion polymer battery was obtained.

### EXAMPLE 2

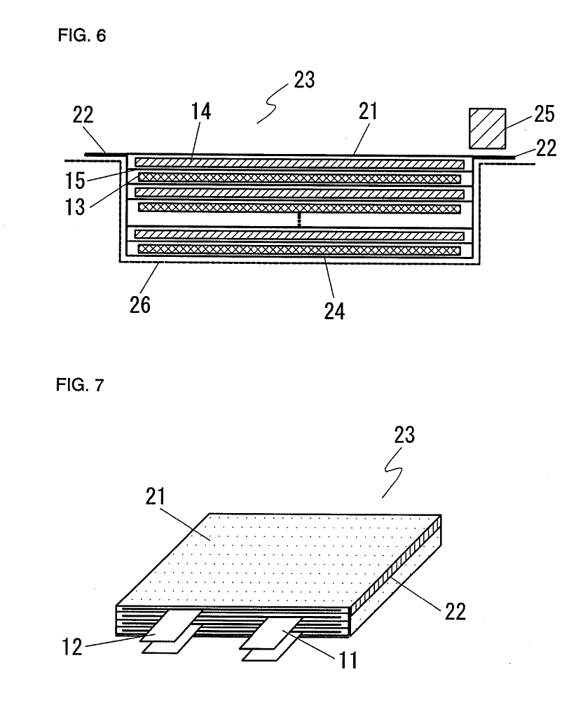

FIG. 6 is a sectional view illustrating the state when insulating porous sheets enclosing the electrode stack are being fusion-bonded and fixed in Example 2 of the stack-type lithium-ion polymer battery of the present invention, and FIG. 7 is an oblique perspective view illustrating the state after fusion-bonding, fixing and bending the insulating porous sheets illustrated in FIG. 6.

The insulating porous sheet 24, which had been cut to 100 mm×170 mm so as to be larger than the coated area of the anode, was placed on a concave mold 26 set at a width of 75 mm so as to be larger than the anode width of 73 mm; the cathode 13, the separator 15, the anode 14 and additionally the separator 15 were sequentially stacked in this order so as to form 10 pairs of the cathodes and the anodes. In this case, the insulating porous sheet located on the uppermost surface corresponds to the insulating porous sheet 21 on the upper end surface of the electrode stack 23. Then, a portion, which was not in contact with the electrodes and was one edge, was fusion-bonded and fixed by applying a fusion-bonding jig 25 from the above, to form a fusion-bonded portion 22 with a fusion-bonding width of 2 mm in such a way that the fusion-bonded portion 22 was located on the upper end surface of the electrode stack 23. The other side was also fusion-bonded and fixed in the same manner and was cut in such a way that the fusion-bonded portion had a width of 2 mm, to fabricate the electrode stack 23, as shown in FIG. 6.

Next, as shown in FIG. 7, the fusion-bonded portions 22 were bent by 90° toward the lower end surface of the electrode stack. The electrode stack 23 had a thickness of 3.15 mm, and hence when the fusion-bonded portions 22 with a width of 2 mm were bent, the bent portions were within the thickness of the electrode stack 23.

When the electrode stack 23 was placed into the embossed laminate package body, the electrode stack 23 was turned over in such a way that the fusion-bonded and fixed insulating porous sheet was disposed on the embossed bottom surface. Except the above, the stack-type lithium-ion polymer battery was obtained as described in Example 1.

### EXAMPLE 3

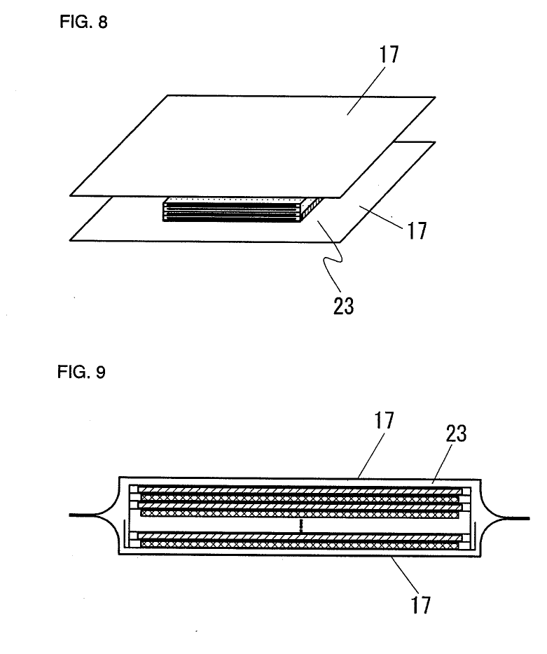

FIG. 8 is an oblique perspective view illustrating the state when the electrode stack is being placed into the laminate package body in Example 3 of the stack-type lithium-ion polymer battery of the present invention, and FIG. 9 is a sectional view illustrating the state after placing the electrode stack illustrated in FIG. 8 into the laminate package body.

In this Example, the electrode stack 23 was fabricated in the same manner as in Example 1, the electrode stack was sandwiched from above and below by non-embossed flat-plate-like laminate package bodies 17 as shown in FIG. 8, and the portion thereof other than the liquid injection portion was thermally fusion-bonded as shown in FIG. 9. Except the above, the stack-type lithium-ion polymer battery was obtained as described in Example 1.

### EXAMPLE 4

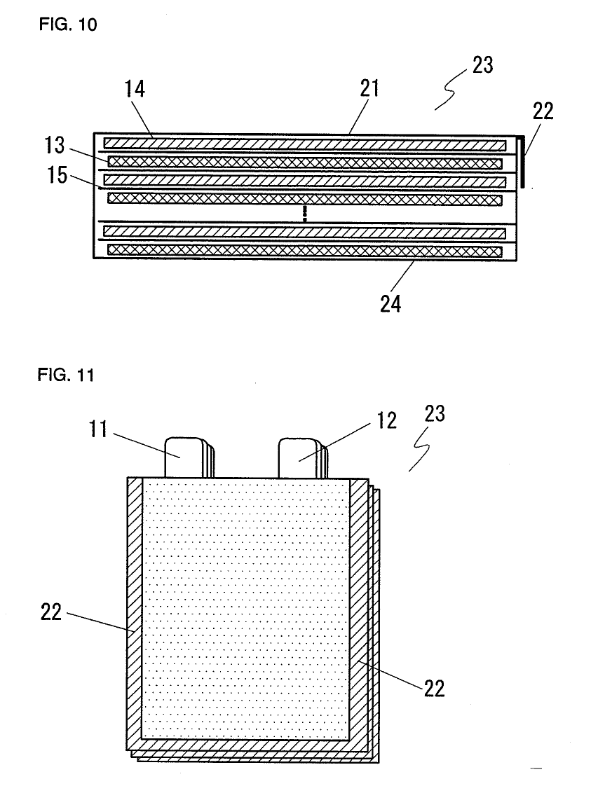

FIG. 10 is a sectional view illustrating the state after the fusion-bonding, fixing and bending the insulating porous sheets enclosing the electrode stack 23 in Example 4 of the stack-type lithium-ion polymer battery of the present invention. The insulating porous sheet 24, which had been cut to 100 mm×170 mm so as to be large enough to enclose the electrode stack 23, was placed at a predetermined position; and in the approximately right half area, the cathode 13, the separator 15, the anode 14 and additionally the separator 15 were sequentially stacked in this order so as to form 10 pairs of the cathodes and the anodes. In this case, the stacking was carried out in such a way that the electrode was placed on the uppermost surface, and the rest half of the insulating porous sheet 24 located on the lower end surface was disposed on the upper surface of the electrode stack 23. Then, a portion, in which the insulating porous sheet 24 and the separators 15 overlapped with each other and which was not in contact with the electrodes, was fusion-bonded and fixed by applying a fusion-bonding jig 25 from the above, to form a fusion-bonded portion 22 with a fusion-bonding width of 2 mm in such a way that the fusion-bonded portion 22 was located on the upper end surface of the electrode stack 23, whereby the electrode stack 23 was fabricated as shown in FIG. 10. Except the above, the stack-type lithium-ion polymer battery was obtained as described in Example 1.

### COMPARATIVE EXAMPLE 1

The stack-type lithium-ion polymer battery was obtained as described in Example 1, except that cathodes were placed into a bag-like separator and stacked with anodes to fabricate the electrode stack 23 as shown in FIG. 11.

### COMPARATIVE EXAMPLE 2

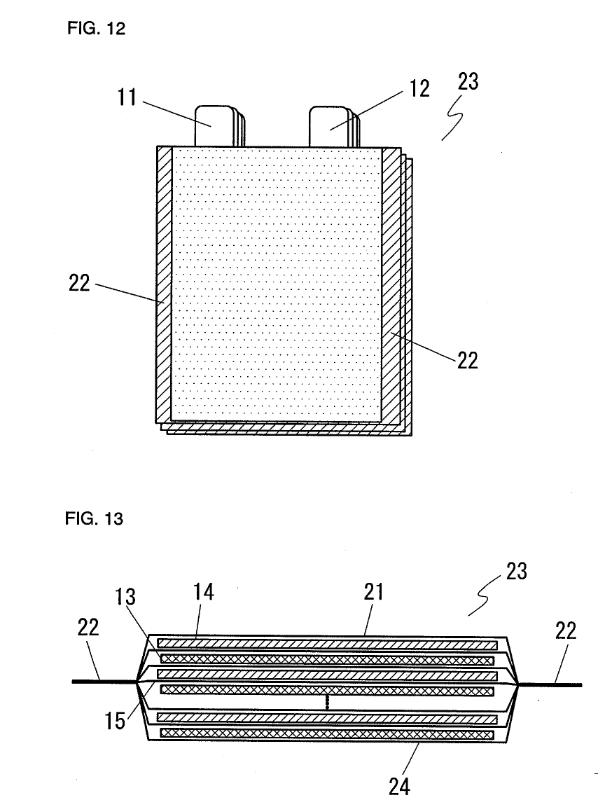

The stack-type lithium-ion polymer battery was obtained as described in Example 1, except that cathodes were placed into a tubular separator made by fusion-bonding two edges thereof and stacked with anodes to fabricate the electrode stack 23 as shown in FIG. 12.

### COMPARATIVE EXAMPLE 3

The stack-type lithium-ion polymer battery was obtained as described in Example 1, except that the separators disposed between the electrodes were fusion-bonded and fixed discontinuously at two positions on the peripheral portion in such a way that the fusion-bonded positions were located at an approximately central portion of the side of the electrode stack 23 as shown in FIG. 13.

Table 1 shows, for each of the stack-type lithium-ion polymer batteries packaged with the laminate material, obtained in Examples and Comparative Examples, the internal short-circuit fault ratios, and the relative times for fabricating the electrode stack and the relative times for placing into the laminate material in terms of the corresponding operation time of Example 1 assumed to be represented by 100. Additionally, the battery capacities at a discharge rate of 1 C are also shown.

TABLE 1

| | | Relative time | | |
|---|---|---|---|---|
| | | for | Relative time | |
| | Internal | fabricating | for | |
| | short-circuit | electrode | placing into | Battery |
| | fault ratio | stack | laminate material | capacity |
| | (%) | (-/piece) | (-/piece) | (Ah) |
| Example 1 | 6 | 100 | 100 | 1.85 |
| Example 2 | 3 | 68 | 110 | 1.85 |
| Example 3 | 6 | 100 | 140 | 1.81 |
| Example 4 | 8 | 110 | 110 | 1.85 |
| Comparative | 5 | 210 | 170 | 1.55 |
| Example 1 | | | | |
| Comparative | 13 | 180 | 220 | 1.79 |
| Example 2 | | | | |
| Comparative | 16 | 110 | 120 | 1.63 |
| Example 3 | | | | |

The battery obtained in Example 1 had a relatively low internal short-circuit fault ratio and had the largest battery capacity of 1.85 Ah, owing to the fact that, the gas release at the time of impregnation of the pre-gel solution was easy, no wrinkle was generated on the separators, and the resistance component was suppressed to the minimum. The battery obtained in Example 2 had a further reduced internal short-circuit fault ratio and the time for fabricating the electrode stack thereof drastically shortened, owing to the fact that the positioning of the electrodes was quite easy in fabrication of the electrode stack. The battery capacity was 1.85 Ah, owing to the fact that no wrinkle was generated on the separators and the resistance component was suppressed to the minimum in the same manner as in Example 1. In Example 3, the time for placing into the laminate material was somewhat longer. The battery obtained in Example 4 had a relatively high internal short-circuit fault ratio, but the workability was approximately the same as Example 1. In addition, the volume efficiency of the battery tended to be improved, owing to the fact that the fusion-bonded portion was only one position.

The battery obtained in Comparative Example 1 had a low internal short-circuit fault ratio, but the time for fabricating the electrode stack thereof was long to be quite low working efficiency, owing to the fact that the separators as many as the electrodes were needed to be made bag-like. Further, the workability in the operations of independently stacking two or more electrodes and attaching the tabs and in placing into the laminate material was quite poor. Furthermore, the battery capacity was degraded, owing to the fact that the gas release at the time of impregnation of the pre-gel solution was restricted and the gas remained inside the electrode stack. The workability in Comparative Example 2 was approximately the same as Comparative Example 1 and the battery capacity was increased as compared to Comparative Example 1 the battery, owing to the presence of the gas release paths. The workability in Comparative Example 3 was poor when the insulating porous sheets were fusion-bonded and fixed to each other and scars, wrinkles and fracture of the separators were generated to cause a high internal short-circuit fault ratio of the battery. Further, the battery capacity was degraded owing to the pressure fluctuation by the surface irregularity generated on the electrode stack, because the fusion-bonded and fixed portion extended to reach the upper end surface of the electrode stack when placed into the laminate material.

As described above, all the electrodes for stacking were enclosed and fixed by insulating porous sheets, so that the displacement of the electrodes at the time of stacking and the generation of wrinkles hardly occurred, to drastically reduce the internal short-circuit fault ratio. Further, the electrodes were stacked, and fusion-bonded and fixed to each other in a lumped manner, so that: the workability was very high, the handling of placing the electrode stack into the laminate material was very easy; the displacement of the electrodes at the time of placing into the laminate material and the generation of the wrinkles and the fracture due to the friction caused by the insulating porous sheets were suppressed; to drastically reduce the internal short-circuit fault ratio. Furthermore, the gas release at the time of the impregnation of the pre-gel solution was easy, so that the resistance was reduced to attain a high battery capacity. Additionally, the fusion-bonded and fixed portion of the insulating porous sheets was disposed on the sides of the electrode stack, so that no pressure fluctuation along the surface direction occurred, and the satisfactory properties were obtained. In other words, the stack-type lithium-ion polymer battery, which had a very high workability, a high capacity and a low internal short-circuit fault ratio, was obtained.

1. A stack-type lithium-ion polymer battery comprising:
a cathode;
an anode;
a separator; and
a gel electrolyte; wherein
an electrode stack in which the cathode and the anode are stacked through the separator is enclosed and fixed by an insulating porous sheet, and is packaged with a laminate material.

2. The stack-type lithium-ion polymer battery according to claim 1, wherein the separator and the insulating porous sheet enclosing the electrode stack are fusion-bonded and fixed at least at one position in the peripheral portion of the side of the electrode stack, not in contact with the cathode and the anode.

3. The stack-type lithium-ion polymer battery according to claim 2, wherein the separator and the insulating porous sheet enclosing the electrode stack are fusion-bonded and fixed discontinuously at least at two positions in the peripheral portion of the side of the electrode stack, not in contact with the cathode and the anode.

4. The stack-type lithium-ion polymer battery according to claim 3, wherein the separator and the insulating porous sheet enclosing the electrode stack are integrated on the lower end surface or the upper end surface of the side of the electrode stack, and are fusion-bonded and fixed discontinuously at least at two positions in the peripheral portion of the side of the electrode stack, not in contact with the cathode and the anode.

5. The stack-type lithium-ion polymer battery according to claim 2, wherein the fusion-bonded portion of the separator and the insulating porous sheet is bent so as to be parallel to the side of the electrode stack.

6. The stack-type lithium-ion polymer battery according to claim 3, wherein the fusion-bonded portions of the separator and the insulating porous sheet are bent so as to be parallel to the side of the electrode stack.

7. The stack-type lithium-ion polymer battery according to claim 4, wherein the fusion-bonded portions of the separator and the insulating porous sheet are bent so as to be parallel to the side of the electrode stack.

8. A stack-type lithium-ion polymer battery comprising:
an electrode stack of pairs of a cathode and an anode between which a separator is interposed, each separator having an extended portion extending from each pair of the cathode and the anode at least at one side-periphery;
a gel electrolyte in contact with each cathode and each anode; and
an insulating porous sheet enclosing and fixing the electrode stack without being in contact with each cathode and each anode, wherein the extended portions of the separators and the insulating porous sheet are placed and bonded together at the side-periphery.

9. The stack-type lithium-ion polymer battery according to claim 8, further comprising a laminate package body having a concave portion in which the electrode stack with the insulating porous sheet is placed.

10. The stack-type lithium-ion polymer battery according to claim 8, wherein each separator has the extended portion at each of the one side-periphery and another side-periphery opposite to the one side-periphery.

11. The stack-type lithium-ion polymer battery according to claim 10, further comprising a laminate package body having a concave portion in which the electrode stack with the insulating porous sheet is placed, wherein the extended portions of the separators and the insulating porous sheet are placed together and bonded at the one side-periphery and the other side-periphery.

12. The stack-type lithium-ion polymer battery according to claim 8, wherein the insulating porous sheet is a nonwoven fabric or a polyolefin microporous membrane made of polyethylene, polypropylene, polystyrene or polytetrafluoroethylene and has a thickness of 5 to 25 μm.

13. The stack-type lithium-ion polymer battery according to claim 12, wherein the separator and the insulating porous sheet are made of the same material.
